(19) United States
(12) Patent Application Publication
(10) Pub. No.: US 2015/0181267 A1
(43) Pub. Date: Jun. 25, 2015

(54) SYSTEMS AND METHODS FOR INFERRING AND FORECASTING VIEWERSHIP AND DEMOGRAPHIC DATA FOR UNMONITORED MEDIA NETWORKS

(71) Applicant: Simulmedia, Inc., New York, NY (US)

(72) Inventors: Mario Morales, Jersey City, NJ (US); Yuliya Torosjan, Astoria, NY (US); Krishna Balasubramanian, Abington, PA (US); Alison Lowery, Atglen, PA (US)

(21) Appl. No.: 14/574,128

(22) Filed: Dec. 17, 2014

Related U.S. Application Data
(60) Provisional application No. 61/917,977, filed on Dec. 19, 2013.

(51) Int. Cl. H04N 21/258; H04N 21/25; H04N 21/442

(52) U.S. Cl. CPC H04N 21/25883; H04N 21/44222; H04N 21/252

(57) ABSTRACT

Currency data regarding the monitored media network including a first viewership count indicating a first number of viewers viewing the monitored media network during a first series of time intervals and demographic information regarding the first number of viewers may be received. Set-top-box viewership data regarding the monitored media network may also be received from a set top box. The set-top-box viewership data may include a second viewership count indicating a second number of viewers viewing the monitored media network during a second series of time intervals. The first and second viewership counts may be transformed into first and second series of data, respectively. The first and second series of data may be compared to with one another determine factors and/or coefficients, which may be applied to the second viewership count to infer and/or forecast demographic information for the second viewership count. The method is generalized to unmonitored networks.

### RELATED APPLICATION

This application is NONPROVISIONAL of U.S. Provisional Patent Application No. 61/917,977 entitled “Measured Networks Basis Factoring Method To Estimate Reach in Unmeasured Networks” filed on 19 Dec. 2013, which is incorporated herein by reference in its entirety.

### FIELD OF THE INVENTION

The present invention relates to inferring and/or forecasting demographic information for unmonitored media network content providers, such as television networks.

### BACKGROUND

Television advertising time, usually in the form of commercials, accounts for a significant portion of the total marketing spend of organizations in a number of geographic markets, including the United States. Typically, television advertisements are marketed on the basis of, among other things, estimated reach, with reach being defined as the total number of people or households exposed or tuned in, at least once, to a television network during a given period of time. Historically, the estimated reach of a television network at a given time has been determined by extrapolating the recorded viewing activities of a sample population obtained from media ratings and measurement companies (e.g., Nielsen Media Research, Comscore, Arbitron, etc.) to forecast and measure behaviors of larger audiences. The directly recorded viewing activity data, which also includes the viewers' age and gender demographics is used as the “currency” for the television industry when marketing their advertising time and is hereinafter referred to as “currency data.” Using the currency data, advertising time slots aired during programming that is forecast to attract a large number of viewers with the desired age and gender demographics is typically sold at higher prices per unit than time slots during programming that is forecast to attract fewer viewers, or viewers with unfavorable demographic statistics.

### BRIEF DESCRIPTION OF DRAWINGS

FIG. 1 depicts a block diagram of an exemplary system for inferring and/or forecasting demographic information for unmonitored media networks, consistent with some embodiments of the present invention;

FIG. 2 depicts a flow chart of an exemplary process for inferring and/or forecasting demographic information for unmonitored media networks, consistent with some embodiments of the present invention;

FIG. 3A depicts a table of exemplary viewership data derived from two sources, consistent with some embodiments of the present invention;

FIG. 3B depicts a graphical representation of the viewership data provided in FIG. 3A, consistent with some embodiments of the present invention;

FIG. 3C provides a table of exemplary factors and coefficients, consistent with some embodiments of the present invention;

FIG. 3D provides a table of an exemplary set of error metrics, consistent with some embodiments of the present invention;

FIGS. 4A-4E provide exemplary received viewership data upon which processes described herein have been executed, consistent with some embodiments of the present invention;

FIG. 5 depicts a flow chart of an exemplary process for inferring and/or forecasting demographic information for unmonitored media networks, consistent with some embodiments of the present invention;

FIGS. 6A and 6B provide graphs of exemplary currency data for two different unmonitored networks, consistent with some embodiments of the present invention; and

FIG. 7 is a block diagram illustrating graphically a methodology for inferring the viewership of unmeasured networks with demographic composition in the context of the currency data.

### DETAILED DESCRIPTION

In the past decades, the number of media content providers, such as television networks, radio networks, and the like (hereinafter referred to as a “media network”) on which advertising time and/or media presentation opportunities are available for sale has increased dramatically. However, currency data is not always available for all of these media networks and/or for all of the media network's available program and advertisement opportunities available for sale to a given purchaser. When currency data is not available, or insufficient for a particular media network, that media network may be referred to herein as an “unmeasured media network.” Furthermore, even when such data exists, it may not be sufficient to accurately forecast and measure potential viewership for the purpose of establishing currency data. With the availability of new device-based TV viewership data sets, such as set-top-box (STB) or connected or smart TV data, the viewing activity for many media networks, especially television networks, regardless of their size or overall popularity, may be collected in sufficient sample sizes as to infer and/or forecast currency data for these networks. This inferred and/or forecast currency data may then be used to, for example, establish values for advertising time slots and provide viewership and demographic information to ensure an advertiser's desired audiences are reached.

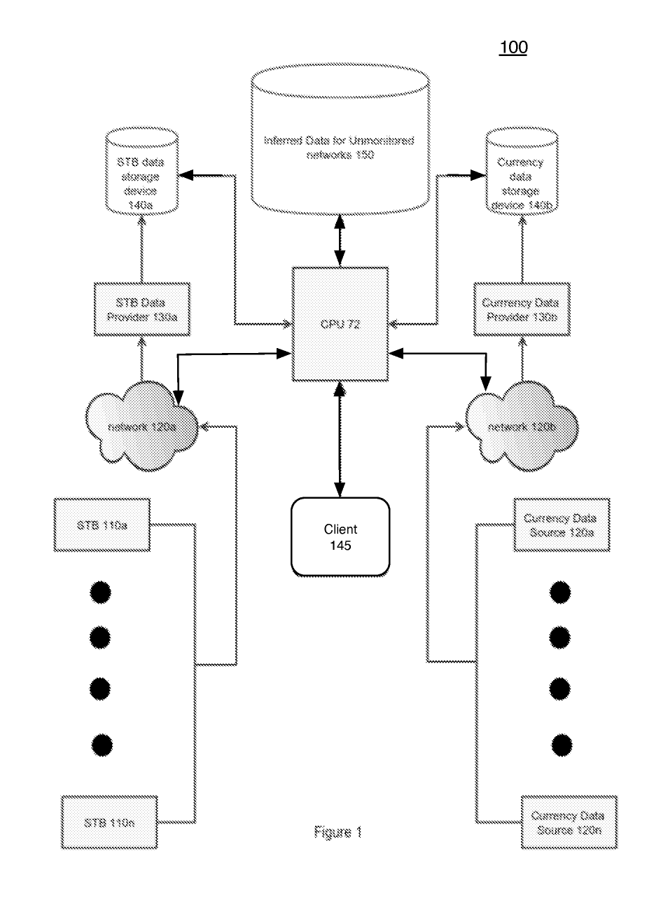

Turning now to FIG. 1, which depicts an exemplary system 100 in which one or more processes described herein may be executed, viewership data, in the form of viewership counts for the number of viewers viewing one or more media networks and/or viewing devices providing content during a particular time interval, may be gathered by one or more set top boxes 110a-110n and/or currency data sources 120a-120n. As used herein, the term exemplary is intended to mean an example, instance or illustration and is not intended to necessarily imply a preference or advantage over other examples, instances or illustrations. Exemplary set top boxes 110a-110n include any device or mechanism (e.g., a cable television box/interface, satellite television box/interface, website, connected or Smart TV interface, satellite radio box/interface, etc.) configured to facilitate the delivery of media content (e.g., television shows, audio, video clips, etc.) to a display device (not shown). Exemplary display devices includes but is not limited to televisions, mobile phones, and computer monitors enabled to provide the media content to a viewer.

Exemplary currency data sources 120a-120n include, media ratings and measurement companies (e.g., Nielsen Media Research, Comscore, Arbitron, etc.). Currency data may include viewership data for a particular network or group of networks as well as demographic information regarding the counted viewers. Exemplary demographic information includes age, marital status, gender, race, preferred language, ethnicity, and geographic location, household size, number of devices in household, and purchasing behavior.

The gathered viewership and currency information may be transmitted from set top boxes 110a-110n and/or currency data sources 120a-120n to a central repository of the STB or other data provider (130a) or measurement company (130b) and/or directly to CPU 72 periodically, continuously, and/or upon request. The received viewership and currency information may be stored in CPU 72 and/or a STB/currency data storage device 140a/b. Client device 145 may be any client computing device (e.g., desktop, laptop, and/or tablet computer) by which a user and/or administrator of system 100 may interact with system components and provide instructions to the components. CPU 72 may be any computing device configured to execute one or more of the processes describe herein. More specifically, CPU 72 may be configured to receive viewership and currency data, transform that data into one or more data series, compare the data series to each other so as to determine one or more factors and/or coefficients to describe the relationships between the series of data, apply the factors to viewership data so as to infer and/or forecast demographic information for the viewership data, determine whether the inferred demographic information aligns and/or is consistent with known demographic information, calculate one or more error metrics for adjusting the factors and/or coefficients, and applying the error adjusted factors and/or coefficients to the viewership data. The inferred and/or forecasted device and/or demographic and/or currency data may be stored in an inferred/forecasted currency data storage device 150.

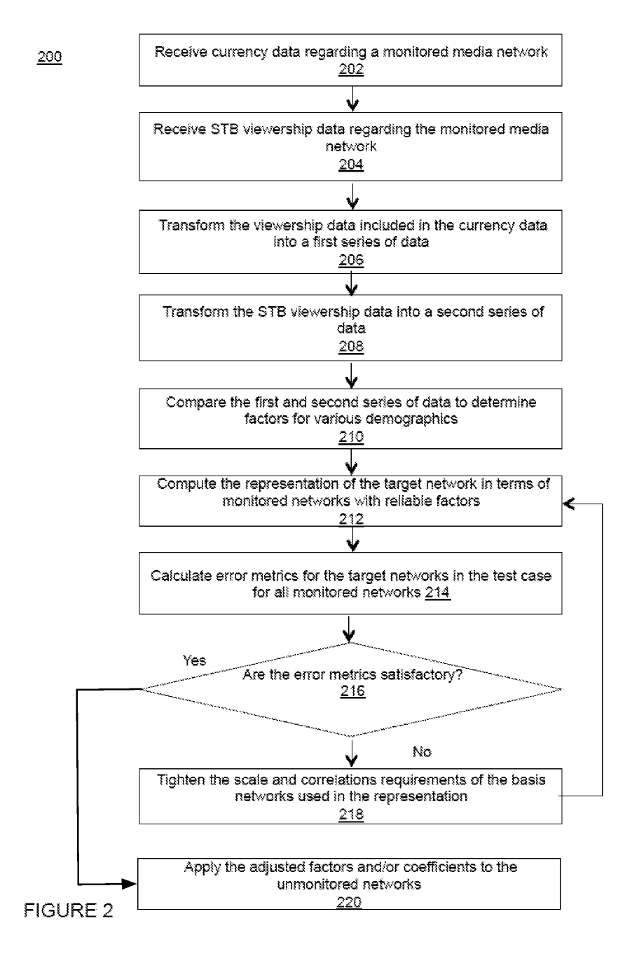

FIG. 2, depicts a process 200 for generating a set of factors and coefficients for inferring demographic information for media network viewership information not previously associated with demographic information. Process 200 may be executed by any of the systems or system components discussed herein. In addition, it should be noted that although the examples discussed below refer to only two different data sets, in practice any number of different data sets may be used to execute the processes, or a portion thereof, described herein.

Initially, currency data regarding a monitored network may be received (step 202). The received currency data may include viewership statistics and demographic information about the viewers of the network. Exemplary viewership information may include a viewership count for a series of time intervals throughout a given time period (e.g., hour, day, month, etc.). The currency data may be received from a single source or a plurality of sources, such as currency data sources 120a-120n.

In step 204, set-top-box (hereinafter, “STB”) or other viewership data regarding the monitored media network may be received from one or more STB or other sources 110a-110n. Exemplary sources for STB or other viewership data include cable television providers, satellite television providers, website visit logs, consumer electronics devices, connected or smart TV's and the like. In most instances, the viewership data does not include demographic information or includes only partial or incomplete demographic information.

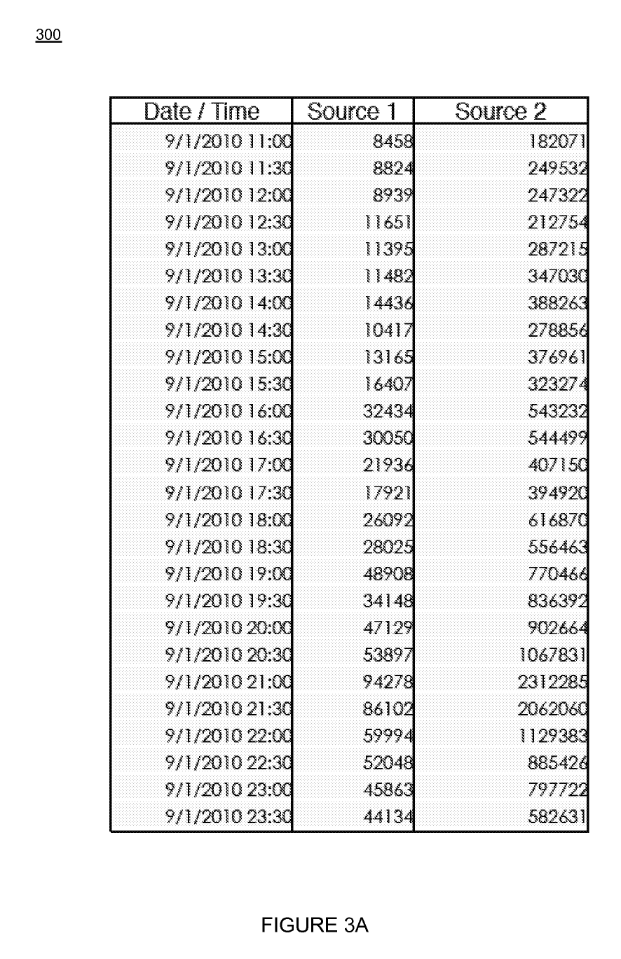

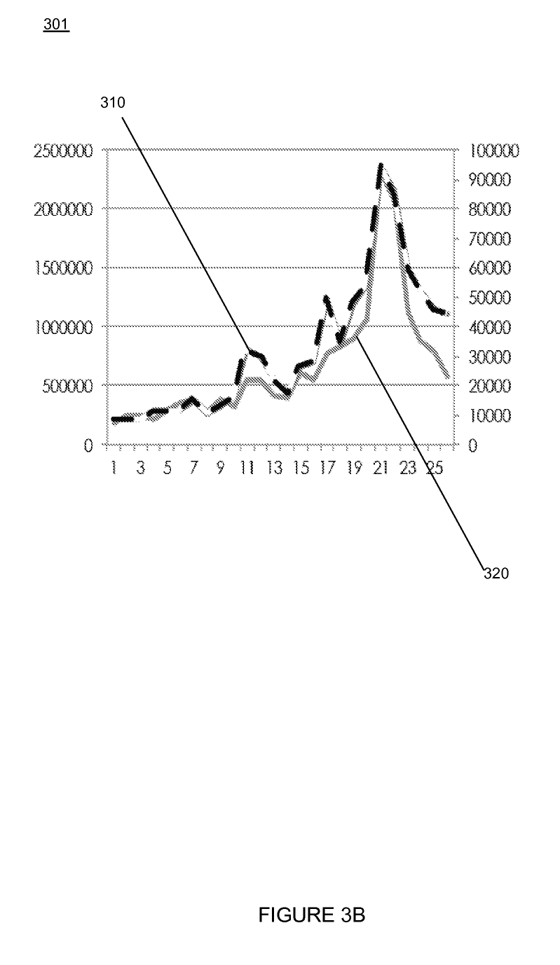

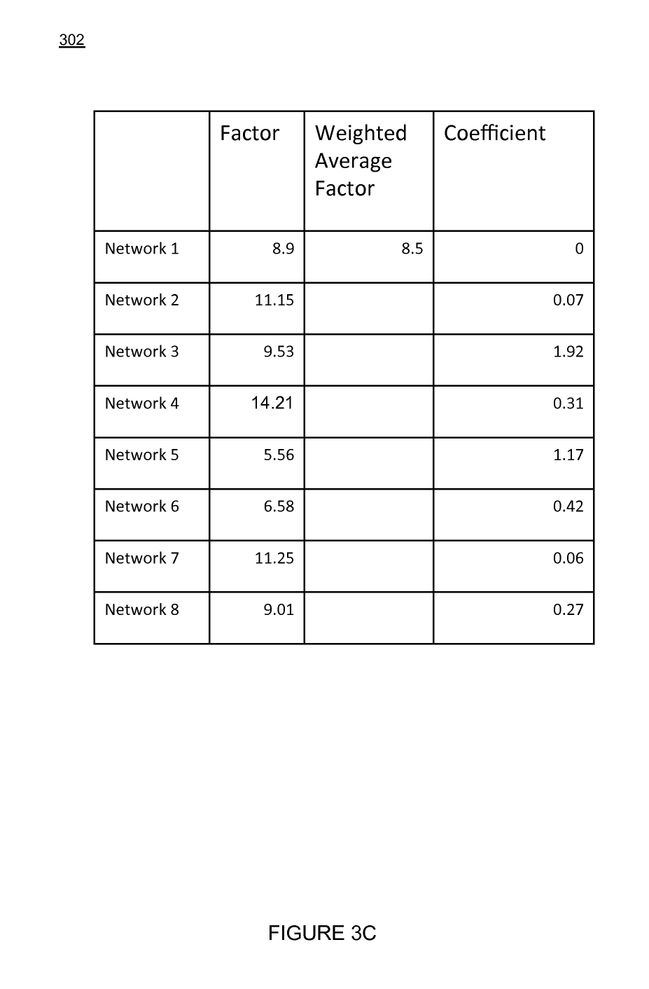

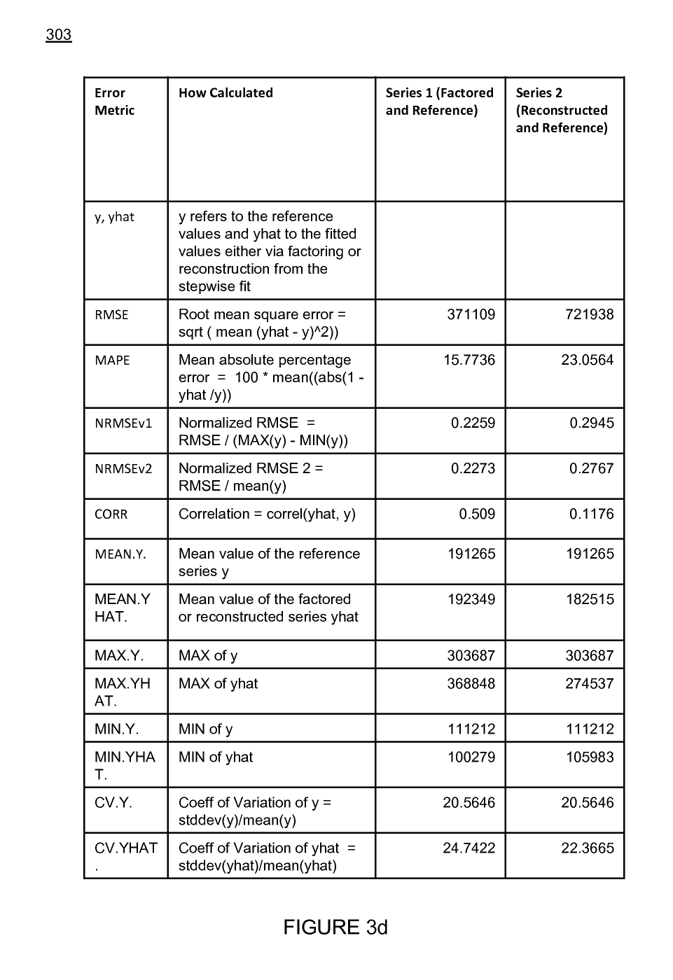

FIG. 3A depicts a table 300 showing exemplary viewership data received from two sources; source 1 and source 2 for Sep. 1, 2010 between the time period of 11:00 and 23:30 in increments of 30 minutes. The viewership data of FIG. 3A is representative of the viewership portion of the currency data received in step 202 or the viewership data received in step 204.

In step 206, the viewership data included in the currency data received in step 202 may be transformed into a first series of data (step 206). The viewership data received in step 204 may then be transformed into a second series of data (step 208). An objective of the transformations of step 206 and 208 is to adjust the viewership data, received from different sources, so that it may be meaningfully compared. For instance, time intervals between or over which data captures occur may be measured using any unit of measure (e.g., seconds, minutes, hours, days, weeks, etc.) and the transformations of step 206 and 208 may include adjusting the viewership data so that the time intervals by which the viewership counts are incremented are consistent with one another.

In some embodiments, the received currency data and/or viewership data may include data regarding multiple media networks. In these embodiments, the transformations of step 206 and/or 208 may include sorting the received currency data and/or viewership data by media network and/or isolating received currency data and/or viewership data for a particular media network of interest for further processing.

In other embodiments, the transformations of steps 206 and/or 208 may include spatial alignment of the two series of data, which incorporate aligning the first and second series of data according to one or more criterion (e.g., geographic observations, demographic observations, network observations, etc.)

In the exemplary data of FIG. 3A, the viewership data for the monitored network is represented as “counts,” which represent the number of viewers for the network for each 30 minute time interval. However, when viewership data is received from different sources, the counts may refer to things other than viewers who are accessing the monitored media network, such as set top boxes, website visits, ratings or other items. In these instances, the transformations of step 206 and/or 208 may include normalization of the units associated with the measured counts and/or removal of the units so that counts measured according to different units may be compared with one another.

In addition, because viewership counts may be received from a variety of sources, the magnitudes of the counts across the various sources may vary. While the absolute magnitudes of the counts are not especially important for purposes of the present invention, relative magnitudes of the counts within each data set reported by each data source are useful. Hence, the transformation of steps 206 and/or 208 may include adjusting the relative magnitudes for different data sources so that the viewership data in the first series of data and second series of data may be compared with one another. For example, FIG. 3B depicts a graphical representation 301 of the viewership data provided in table 300 following transformation of the data from source 1 into a first series of data 310 and the data from source 2 into a second series of data 320, where the scale for the viewership data received from source 1 (i.e., 0-2,500,000) is different from the scale for the viewership data received from source 2 (i.e., 0-100,000). Thus, the graphical representation 301 depicts the first series of data 310 and the second series of data 320 on scales appropriate for each respective data set and against a common time axis so that the first series of data 310 and the second series of data 320 may be readily compared to one another. In this way, the relative maxima and minima of the first series of data 310 and the second series of data 320 may be correlated to and/or compared with one another (step 210) in order to determine, for example, overlapping maxima and minima for first series of data 310 and the second series of data 320 as well as discrepancies between first series of data 310 and the second series of data 320. The comparison between the first series of data 310 and the second series of data 320 may be performed with any level of granularity and different correlation techniques or mechanisms may be used to determine a “best fit” between the different data sets.

In some instances, the comparison of the first series of data 310 and the second series of data 320 may include factoring the first series of data 310 and the second series of data 320 to determine one or more factors and/or regression coefficients describing transformations between the first series of data 310 and the second series of data 320. In this way, execution of step 210 may enable transformations of viewership data through factoring so that one data set may be compared with and/or substituted for another.

Next, the factors and/or coefficients are applied to the viewership data and an inference of demographic information for the viewership data is made (step 212). FIG. 3C provides a table 302 that includes exemplary factors for media networks 1-8, as may be determined via step 210, and coefficients determined via step 212, that may be applied to viewership data, for each respective network, in order to infer demographic information for each the respective network (step 212).

The inferred demographic information may then be compared to the known demographic information for any monitored network and, in step 216, it may be determined whether the inferred demographic information for the viewership data aligns with, or is sufficiently similar to, the known demographic information. An exemplary set of error metrics is provided in table 303 of FIG. 3D. In exemplary table 303, one or more error metrics may be calculated (step 214) by comparing the inferred demographics series generated for monitored networks by applying the factors to the viewership data. Table 303 also provides a second set of one or more error metrics which may also be calculated (step 214) by comparing the reconstructed demographics generated by applying the coefficients determined in step 212 and the factors in 210 to the viewership data of the basis networks. The result is deemed acceptable if the errors for the reconstructed series is smaller or similar in magnitude to the errors for the factored series. When the inferred demographic information for the viewership data aligns with and/or is sufficiently similar to the known demographic information, process 200 may end (step 220).

When the inferred demographic data does not align with the known demographic data, then one or more adjustments to the factors and/or coefficients may be determined in order to improve the alignment of the inferred demographic data with the known demographic data (step 218). The method includes the restriction of the basis networks to those found to be of similar scale within the viewership data and the currency data, the restriction of the basis to those networks found to have high correlations and stable factors from one time period to the next.

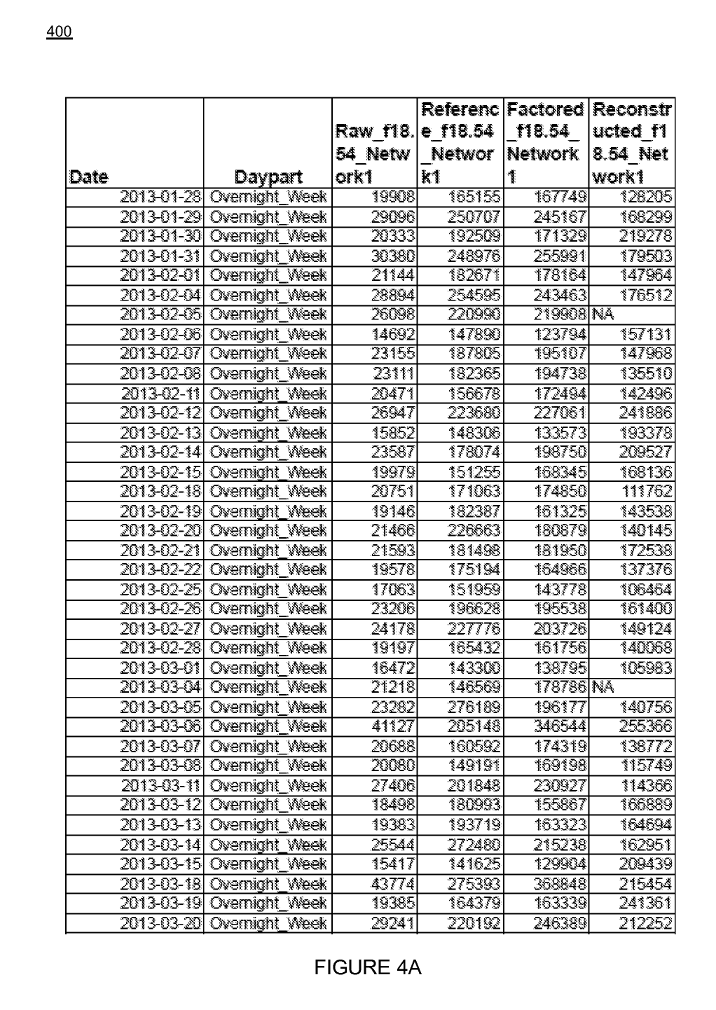

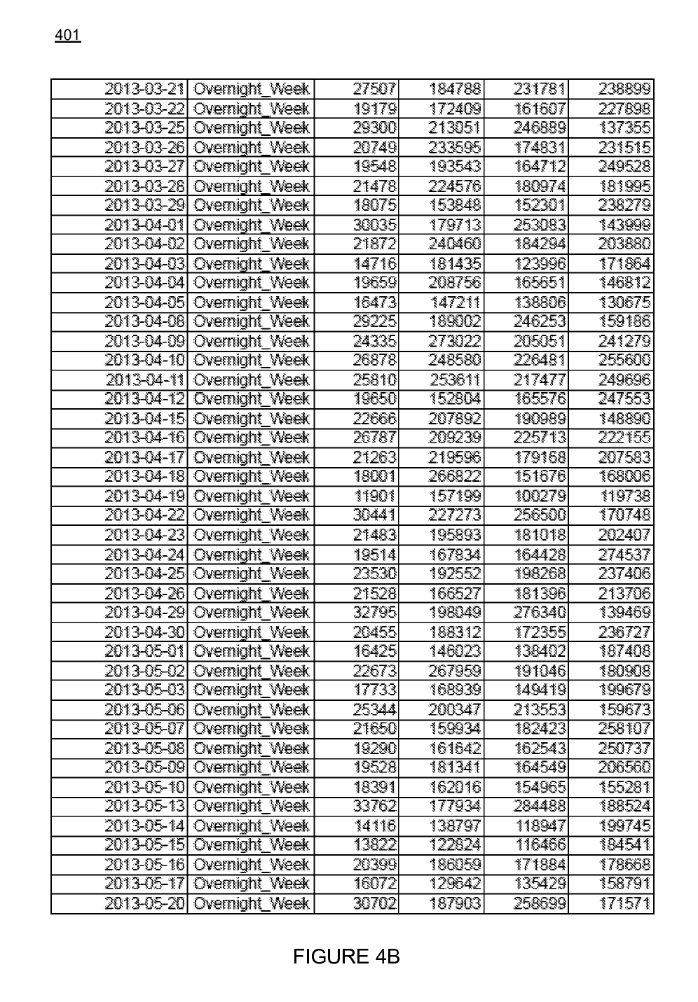

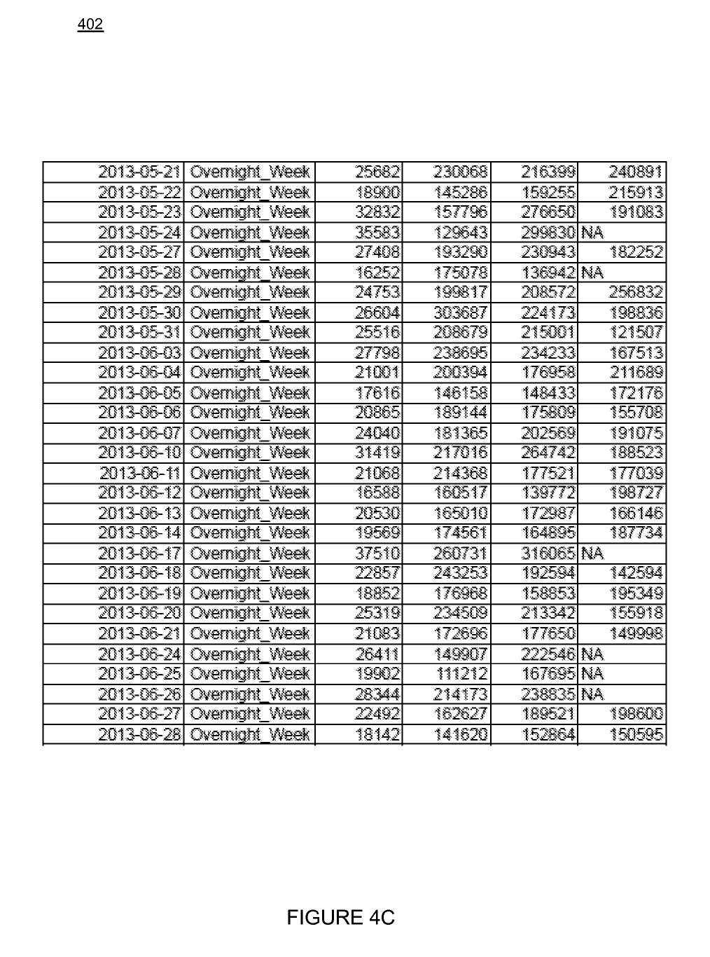

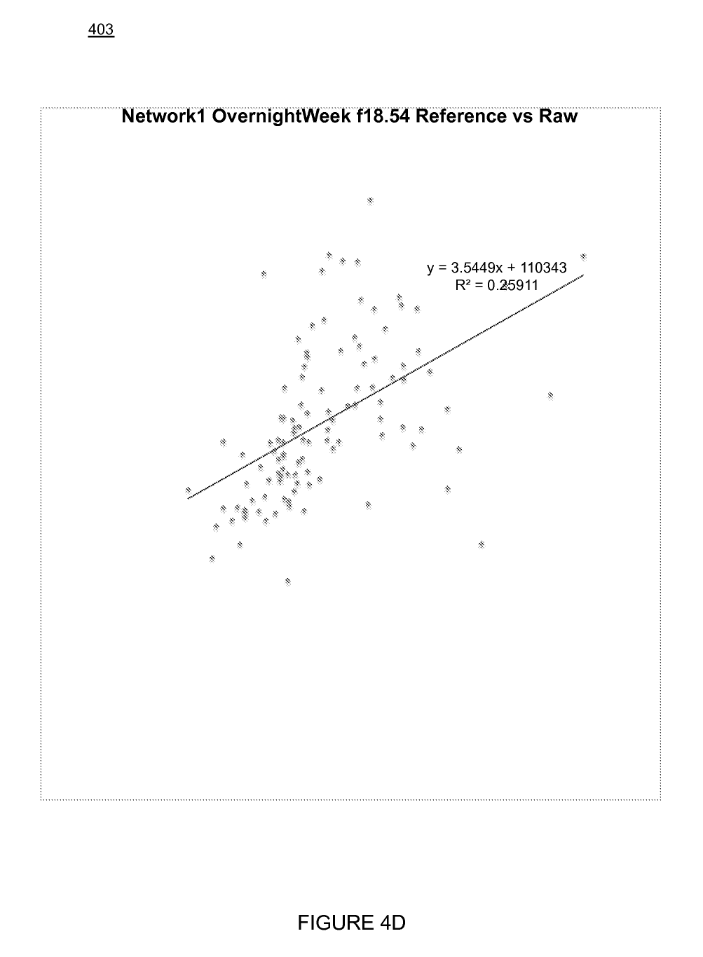

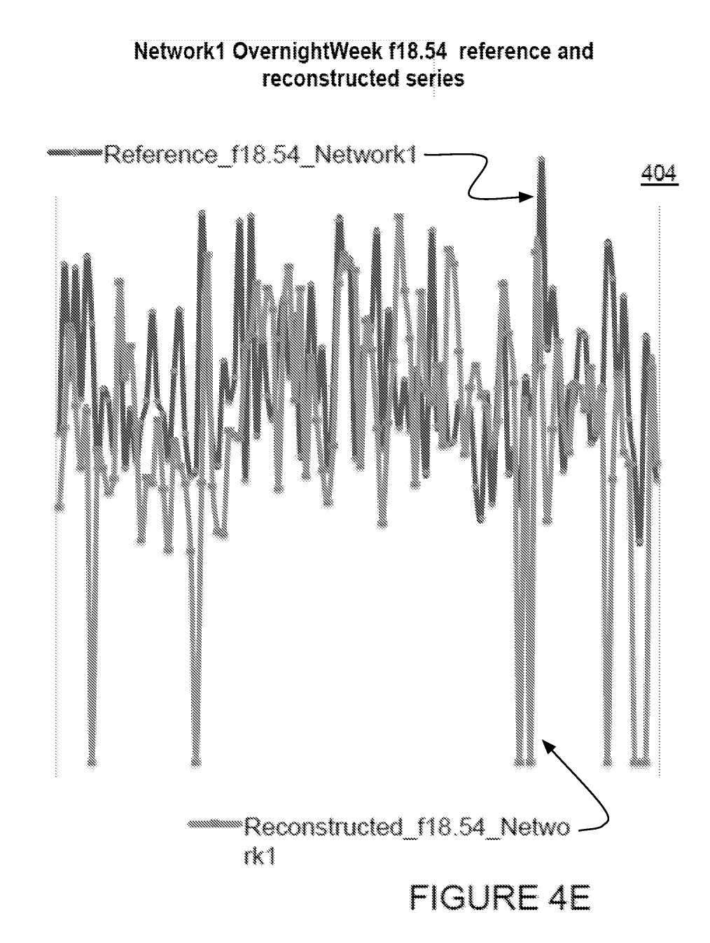

Steps 212-218 may be iteratively repeated until the inferred demographic information is sufficiently aligned with the known demographic information for the monitored networks. The adjusted factors and/or coefficients may then be applied to the viewership data of the unmonitored networks (step 220). FIGS. 4A-4E provide an example of received viewership data upon which process 200 has been executed. FIGS. 4A-4C provide tables 400, 401, and 402 respectively. Some entries in tables 400, 401, and 402 are represented as NA, which indicates that the reconstruction for the data for the concerned date failed due to incompleteness of basis for performing the reconstruction.

Each of these tables, 400, 401, and 402, represent a different portion of a data table for a particular monitored network (network 1), for which we calculate a reconstructed series with the aim of estimating the errors in the process. Column 1 of tables 400, 401, and 402 provides the date (year, month, day) associated with a particular data point. Column 2 tables 400, 401, and 402 provides the Daypart (i.e., part of the day), which for the data of tables 400, 401, and 402 is the overnight week portion of the daypart. Column 3 provides raw viewership counts in the device data for network 1 (represented on table 400 as “Raw_f18.54_Network1”). Column 4 provides reference data for Network 1 during the measured time intervals (represented on table 400 as “Reference_f18.54_Network1”). The reference data for network 1 refers to the known demographic information for Network 1 during the time intervals for which data is captured. Column 5 provides factored data for Network 1 during the measured time intervals (represented on table 400 as “Factored_f18.54_Network1”). Factored data may be generated via execution of step 212 on the raw data of column 3. Column 6 provides reconstructed data for Network 1 during the measured time interval (represented on table 400 as “Reconstructed_f18.54_Network1”). Reconstructed data may be generated via execution of step 220 using the coefficients and factors specified in table 303 FIG. 3D.

FIG. 4D provides a graph 403 that plots the reference data of column 4 (on the y axis) with regard to the raw data of column 3 (on the x axis). Graph 403 also provides a best-fit equation for the plotted data, which is represented by a line as well as trend line equation:

y=3.5449x+110343

R²=0.25911

where:
y=the value on the y axis;
x=the value on the y axis; and
R² is the coefficient of determination

FIG. 4E provides a graph 404 that plots the reference data of column 4 (on the y axis) with regard to the date of column 1 (on the x axis). Superimposed upon this plot is a plot of the reconstructed data of column 6 (on the y axis) with regard to the date of column 1 (on the x axis). Differences between the plot of the reference data and the reconstructed data may be seen as errors, for which error metrics, like those discussed with regard to table 303 and/or step 218 may be applied.

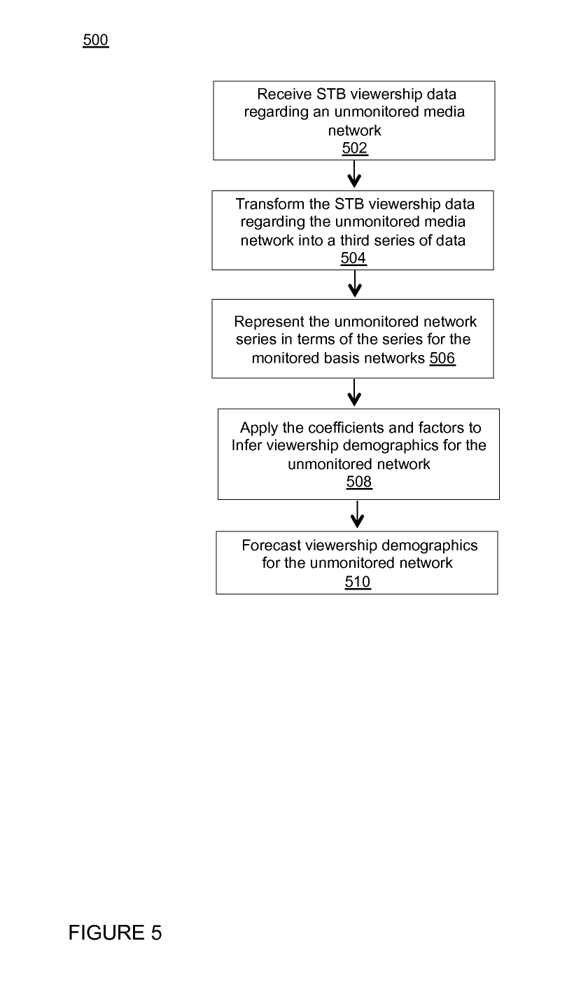

FIG. 5 depicts a process for inferring viewership demographics for an unmonitored network. An unmonitored network is a network for which demographic, and therefore currency information, is not available or incomplete. Process 500 may be executed by any of the systems or system components discussed herein.

In step 502, viewership data regarding an unmonitored network may be received from one or more sources 110a-110n. The received viewership data may then be transformed into a third series of data so that it may be compared to and/or correlated with the first and/or second series of data (step 504). The transformation of step 504 may be similar to the transformations of steps 206 and 208 as discussed above with regard to FIG. 2 and may include, for example, categorizing the received viewership data by time of day and network as well as the regression and normalization analysis discussed above.

Next the coefficients in terms of the basis networks are determined in step 506 which may be similar to steps 212 to 218 of FIG. 2. The coefficients and the known factors for the basis networks may then be used in order to infer viewership demographics for the unmonitored network (step 508). The results of step 508 may also be used to forecast viewership demographics for the unmonitored media network (step 510). The forecasting of step 510 may include predicting the demographics of viewers that are likely to view the unmonitored media network during a given time interval based on, for example, historical viewership data, and the results of processes 200 and/or 500. The inferred and/or forecast demographics and the viewership information may then be converted into inferred currency data (a combination of the inferred demographics and the viewership information) (step 510).

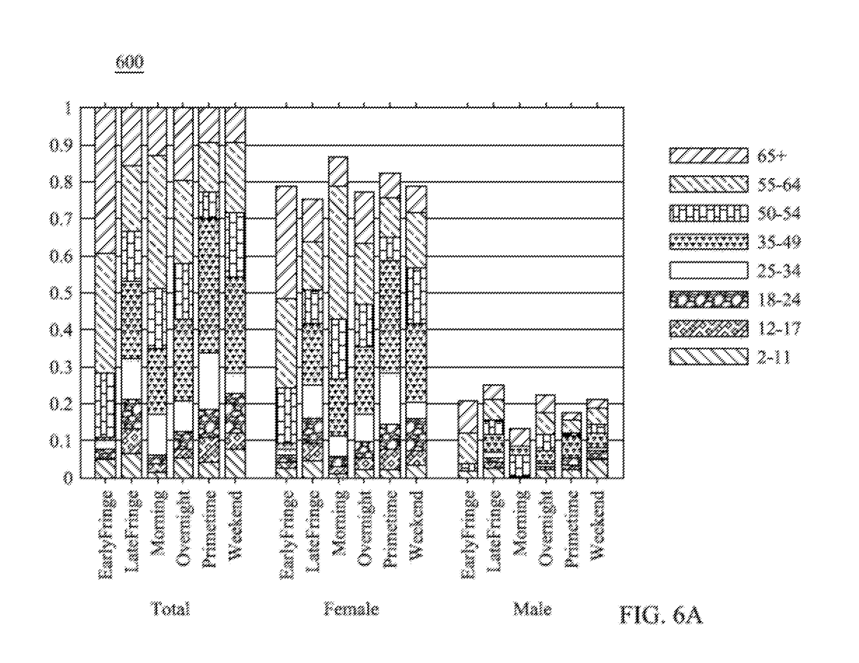

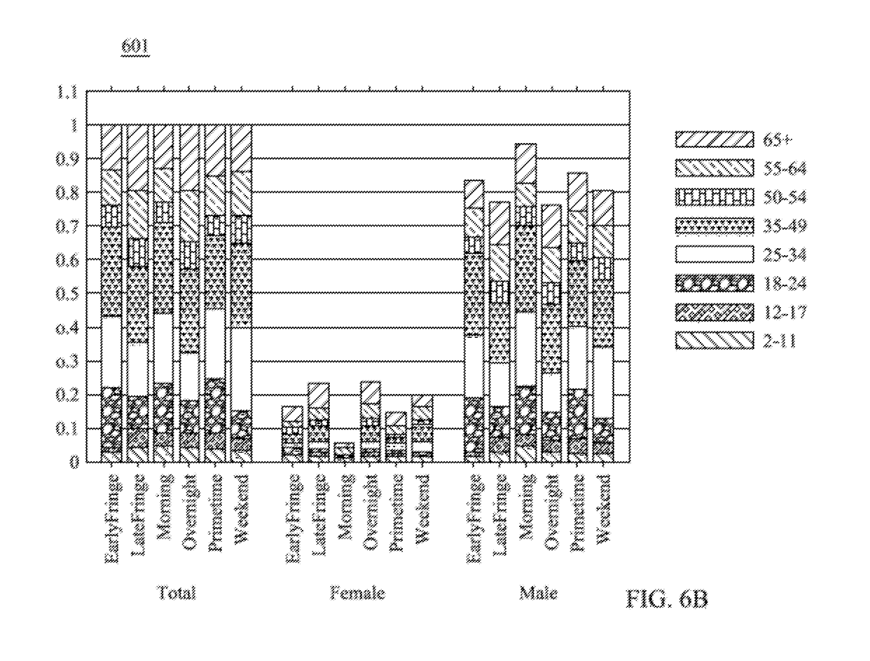

FIGS. 6A and 6B provide graphs 600 and 601, respectively, of exemplary currency data for two different unmonitored networks that is generated via execution of process 200 and/or 500. The currency data of graphs 600 and 601 is provided in terms of viewership count (represented as the decimal form of a percentage (0.1, 0.2, etc.) along the y axis and time of day (early fringe, later fringe, morning, overnight, primetime, and weekend) along the y axis and demographic information, which in these examples is both age (represented as different colors according to the graph key) and gender (represented along the x axis).

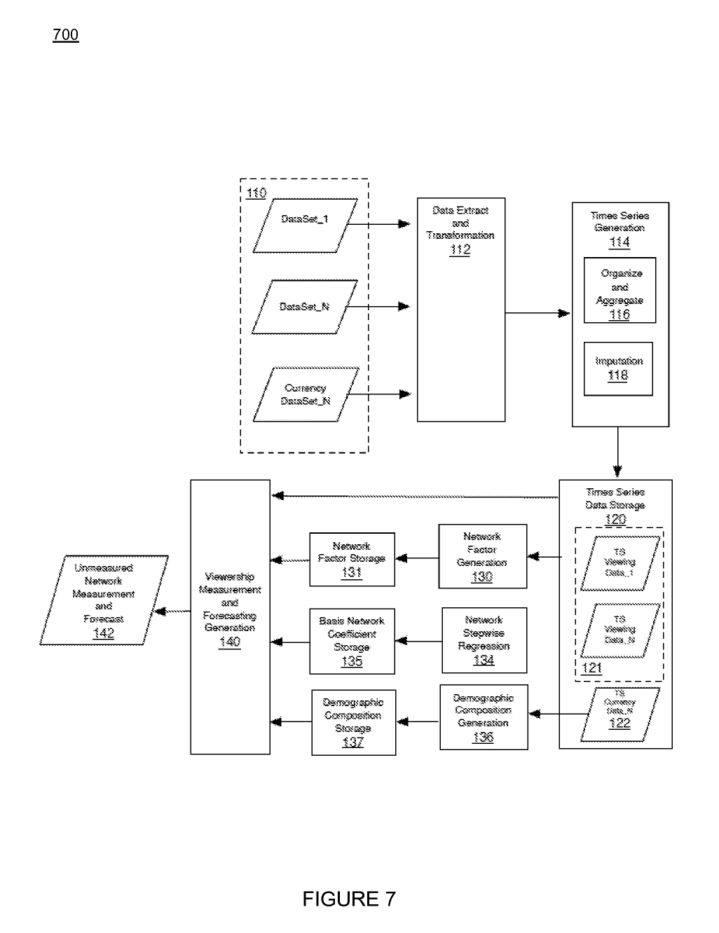

FIG. 7 is a block diagram depicting an exemplary process for inferring demographic data. Initially, a number of data sets; dataset_{—}1, dataset_N and currency dataset_N, collectively referred to data sets 110 are received (e.g., synchronously or asynchronously) from a variety of data sources, such as set top boxes, television satellite programming providers, etc. Currency dataset_N may be received from media ratings and measurement companies (e.g., Nielsen Media Research, Comscore, Arbitron, etc.). Data sets 110 may include count information regarding viewership for one or more television networks, programs, advertising spots, and/or demographic information. Data matching one or more criteria (e.g., network viewed, time of day, etc.) may be extracted from data sets and transformed so as to be organized in a time series 110 at box 112. At box 114, the extracted and transformed data are arranged in time series. Included in the time series generation of box 114 are data organization and aggregation 116 and imputation 118. Execution of imputation 118 enables imputing of any missing data based on, for example, pattern similarities exhibited by the data set itself and/or other data sets. The execution of the time series generation yields time series aligned data sets for each data set 110, which are referred to in FIG. 7 as time series data sets 121 (labeled as “TS Viewing Data_{—}1” and “TS Viewing Data N”) and time series currency data 122 (labeled as TS Currency Data_N″). Time series data sets 121 and time series currency data 122 may be stored at time series data storage 120.

The time series data sets 121 may then be factored with regard to one another to generate network factors 130. The factoring may include development of mappings used to express one time series data set 121 and/or time series currency data sets 122 as a function of one or more of the other time series data sets 121 and/or time series currency data sets 122. In many instances, network factor generation 130 may involve regression analysis so that individual factors for each of the time series data set 121 and/or time series currency data sets 122 with respect to individual ones of the other time series data set 121 and/or time series currency data sets 122 may be developed. The quality of the factors may be assessed using generally accepted statistical quality measures (e.g., root mean square error computations, mean absolute percentage error computations, etc.).

A demographic viewership composition for any given network and time interval may be determined by calculating the demographic composition of the network 136 using the time series currency data 122, which includes the demographic characteristics of the network viewers. The demographic composition 137 may then be then applied to the same network in the comparative time series viewing data 121 to infer viewership demographics for an unmeasured network in terms of the time series currency data 122. Often times, application of demographic composition 137 is done using the best linear representation of unmeasured networks time series viewing data as determined using stepwise regression 134 of the initially received data set for the unmeasured network 110. The stepwise regression may be used to describe the time series for an unmeasured network as a linear combination of a time series of a set of basis measured network (for which currency data is available) from viewership data.

Unmeasured network viewership measurements and forecasts 142 in terms of the time series currency data 122 may then be calculated by, for example, applying factors 131, demographic composition 137 fractions for the measured networks making up the best linear representation of the unmeasured network, and a basis network coefficient for the time series viewing data 121. An exemplary formula for generating the unmeasured network viewership estimate 140 is as follows:

v(t)=a₁f₁v₁(t)+a₂f₂v₂(t)+ . . . aₙfₙvₙ(t)

where: a=linear coefficient for the basis network;
f=a network factor for the basis network; and
v=a viewership within the demographic composition.
t=time period

Hence, systems and methods for inferring and forecasting viewership and demographic data for unmonitored media networks have been herein described.

What is claimed is:

1. A computer implemented method comprising:
receiving currency data regarding a monitored media network form a source of the currency data, the currency data including a first viewership count indicating a first number of viewers viewing the monitored media network during a first series of time intervals and demographic information regarding the first number of viewers;
receiving set-top-box viewership data regarding the monitored media network from a set top box, the set-top-box viewership data including a second viewership count indicating a second number of viewers viewing the monitored media network during a second series of time intervals;
transforming the first viewership count into a first series of data;
transforming the second viewership count into a second series of data, wherein the transformation of first viewership count and the transformation of the second viewership count facilitate comparison of the first series of data to the second series of data;
comparing the first and second series of data to determine one or more factors; and
applying the factors to the second viewership count to infer demographic information for the second viewership count.

2. The computer implemented method of claim 1, further comprising:
comparing the inferred demographic information to the demographic information included in the received currency data regarding the first number of viewers; and
calculating one or more error metrics to estimate the quality of a representation of the inferred demographic information.

3. The computer implemented method of claim 2, further comprising:
refining a set of basis networks using measures of correlation and similarity of scale to generate an improved set of factors and coefficients;
using the improved set of factors and coefficients to infer a corrected demographic information for the second viewership count.

4. The computer implemented method of claim 1, further comprising:
combining the inferred demographic information and the second viewership count to inferred currency data for the monitored media network.

5. The computer implemented method of claim 4, further comprising:
comparing the inferred currency data to the received currency data; and
calculating one or more error metrics to be applied to the factors and coefficients responsively to the comparison.

6. The computer implemented method of claim 1, further comprising:
receiving viewership data regarding an unmonitored media network, the viewership data including a third viewership count indicating a third number of viewers viewing the monitored media network during a third series of time intervals;
transforming the received viewership data regarding the unmonitored media network into a third series of data; and
computing coefficients and using the factors and coefficients to infer demographic information for the third viewership count.

7. The computer implemented method of claim 6, further comprising:
combining the inferred demographic information and the third viewership count into inferred currency data for the unmonitored media network.

8. The computer implemented method of claim 7, further comprising:
designing a pricing scheme for the sale of viewership opportunities provided by the unmonitored media network responsively to the inferred currency data regarding the unmonitored media network.

9. The computer implemented method of claim 6, wherein the transforming of at least one of the first viewership count, the second viewership count, and the third viewership count includes execution of at least one of a factoring process and a normalization process.

10. The computer implemented method of claim 6, wherein the viewership data including the third viewership count is received from a plurality of set top boxes.

11. The computer implemented method of claim 1, wherein the inferred demographic data includes at least one of viewership age, gender, preferred language, race, and ethnicity.

12. A computer implemented method comprising:
receiving currency data regarding a monitored media network form a source of the currency data, the currency data including a first viewership count indicating a first number of viewers viewing the monitored media network during a first series of time intervals and demographic information regarding the first number of viewers;
receiving set-top-box viewership data regarding the monitored media network from a set top box, the set-top-box viewership data including a second viewership count indicating a second number of viewers viewing the monitored media network during a second series of time intervals;
transforming the first viewership count into a first series of data;
transforming the second viewership count into a second series of data, wherein the transformation of first viewership count and the transformation of the second viewership count facilitate comparison of the first series of data to the second series of data;
comparing the first and second series of data to determine one or more factors and coefficients; and
applying the factors and coefficients to the first viewership count to forecast demographic information for the first viewership count.
